(19) United States
(12) Patent Application Publication
(10) Pub. No.: US 2018/0174478 A1
(43) Pub. Date: Jun. 21, 2018

(54) Decision-Making System and Method

(71) Applicant: Joanne Seymour, Ottawa (CA)

(72) Inventor: Joanne Seymour, Ottawa (CA)

(21) Appl. No.: 15/384,939

(22) Filed: Dec. 20, 2016

(51) Int. Cl. G09B 19/00; G01G 1/18

(52) U.S. Cl. CPC G09B 19/00; G01G 1/18

(57) ABSTRACT

A decision-making system includes a balance scale, a plurality of stones, a journal, and a writing utensil. The decision-making system is useful for visualizing the positive and negative aspects of a situation in order to come to a logical decision. Stones of a first color and stones of a second color of varying weights are used to represent positive and negative aspects of a decision and their corresponding magnitudes as perceived by a user. The stones are placed into opposite sides of the scale, which visually indicates the weightier of the two sides. If the stones of a first color are heavier, the decision may be perceived to be a positive one; if the stones of a second color are heavier, the decision may be a negative one. Alternatively, the decision-making system may be used for evaluating the positivity or negativity of a situation which does not necessitate a decision.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of visualization tools of existing art and more specifically relates to a decision-making tool.

### 2. Description of Related Art

Decision-making is the process of identifying and choosing options based on the values and preferences of the decision-maker. Decision-making is a logical process resulting in the selection of a determination or a course of action among several options. Every decision-making process produces a solution; it may or may not prompt action. Decision-making may be considered a problem-solving activity completed by a solution deemed to be satisfactory. It is therefore a process which can be more or less rational or irrational and can be based on explicit or tacit knowledge.

However, the options considered during decision-making often have both desirable and undesirable traits. These traits are frequently difficult to quantify, making decision-making processes convoluted. A decision-maker may be unsure whether an option is truly a desirable one. A suitable solution is desired.

U.S. Pub. No. 2008/0211181 to Joseph Thomas Fedison relates to a decision-making system and method. The described decision-making system and method includes a container having an opening, an object with decision-making indicia, the object having at least two sides and movably located inside the container, and a cover attached to the container to close the opening.

### BRIEF SUMMARY OF THE INVENTION

In view of the foregoing disadvantages inherent in the known visualization tool art, the present disclosure provides a novel decision-making system and method. The general purpose of the present disclosure, which will be described subsequently in greater detail, is to provide a decision-making system and method.

A decision-making system is disclosed herein. The decision-making system includes a balance scale including a stand, a pivoting balance arm having a left member, a right member, and a fulcrum, at least two receptacles each having a basin and a rim, and at least two receptacle-suspending members; multiple stones including a selection of stones of a first color and a selection of stones of a second color; a journal including a cover and pages; and a writing utensil configured to record information in the journal. The stand may be manufactured in various configurations.

The balance scale, the stones, the journal, and the writing utensil are configured as a kit for making decisions. The journal and the writing utensil are used for recording perceived positive and negative attributes of a decision, and the stones comprise a physical placeholder for the perceived positive and negative attributes of the decision. The balance scale helps determine the overall positivity or negativity of a decision by providing a visual representation of the decision. The balance scale is designed to determine an imbalance of weight between the stones of a first color on one side of the scale and the stones of a second color on the other, providing a material representation of the decision-making process. The stones vary in individual shape and volume to represent varying magnitudes of positivity or negativity. Accordingly, the stones vary in mass, applying forces to the balance scale proportional to their size, when placed. The option is available of having more than one balance arm on each side. i.e. 2 children, each have one side with 2 balance scales.

The pivoting balance arm of the balance scale is oriented horizontally when balanced, and the balance scale is oriented vertically, being constructed to supporting the scale on a flat surface. The pivoting balance arm pivots about its fulcrum, so that the left and right members produce equal and opposite moments about the fulcrum. Similarly, the receptacles are divided equally between the left and right members and also produce equal and opposite moments about the fulcrum, so that the scale is balanced when empty.

The left member causes a counter-clockwise rotation of the pivoting balance arm about the fulcrum when the weights are applied, and the right member causes a clockwise rotation of the pivoting balance arm about the fulcrum when the weights are applied. The receptacles are designed to contain the stones, each having sufficient internal volume for multiple stones. The receptacle-suspending members of the balance scale flexibly connect the receptacles to the pivoting balance arm.

The receptacles of the balance scale are structured and arranged to receive the stones, with one side receiving stones of a first color and the other side receiving stones of a second color. In this way, the stones of a first color (black or other) can be weighed against the stones of a second color. The white (or other color) stones of a second color thereby cause an imbalance between left and right members when they are applied in uneven weights relative to each other. As a result, the balance scale visually demonstrates an imbalance between the weights as it rotates either clockwise or counter-clockwise in accordance with the weightier side.

According to another embodiment of the invention, a method of decision-making is disclosed herein. The method of decision-making may include the steps of contemplating the positive and negative aspects of a decision; recording the positive aspects and negative aspects in a journal using a writing utensil; placing a plurality of stones in the receptacles of a balance scale, with the stones of a first color, such as white, representing positive aspects being placed on one side of the scale, and the stones of a second color, such as black, representing negative aspects being placed on the other; weighing the stones of a first color against the stones of a second color; determining a balance and alternately an imbalance of the stones, to form a decision based on the positivity or negativity of the weight of the stones; wherein a user is able to enact a decision according to the result. Stone colors may vary. In another preferred embodiment, a method for decision-making may include placing a time limit on a user listing positive and negative aspects of a decision.

The decision-making system may be marketed under the trade names “WEIGHT LIFE SCALE”, “WEIGHT IN”, “WEIGHING IN”, “THE BALANCER” or other such trade names.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a decision-making system and method, constructed and operative according to the teachings of the present disclosure.

FIG. 1 is a perspective view of the decision-making system during an ‘in-use’ condition, according to an embodiment of the disclosure.

FIG. 2 is a profile view of a balance scale of the decision-making system of FIG. 1, according to an embodiment of the present disclosure.

FIG. 3 is a perspective view of receptacles of the balance scale of the decision-making system of FIG. 2, according to an embodiment of the present disclosure.

FIG. 4 is a perspective view of a journal and writing utensil of the decision-making system of FIG. 1, according to an embodiment of the present disclosure.

FIG. 5 is a flow diagram illustrating a method of decision-making, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a visualization tool and more particularly to a decision-making system and method as used to improve the decision-making process.

Generally, the decision-making system is a kit including a balance scale, a plurality of stones, a journal, and a writing utensil. The balance scale includes a single arm which pivots about a centrally mounted hinge for measuring a balance or imbalance between two payloads. The scale indicates a heavier payload by lowering towards the heavier side.

The decision-making system is useful for visualizing and committing to a decision. A user may use the journal and a writing utensil to record both the positive and negative aspects of a decision. These aspects may be represented by the stones; stones of a first color representing positive decisions, and stones of a second color representing negative decisions. The stones vary in size and weight, and may be used selectively to represent aspects of varying positivity and negativity. For example, a very positive aspect may be represented by a large white stone; a marginally negative aspect may be represented by a small black stone.

In use, the decision-making system requires a user to place the selected stones of a first color (positive) and the selected stones of a second color (negative) in opposite sides of the balance scale. A user may then allow the scale to settle and determine which side of the scale bears more weight. If the stones of a first color are heavier than the stones of a second color, the decision is judged to be positive and should be followed through. If the stones of a second color are heavier than the stones of a first color, the decision is judged to be negative. If the weight of the stones of a first color is equal to the weight of the stones of a second color, then the judgement of the decision is neutral.

Applications of the decision-making system include any situation in which a user may need to make a choice. For example, a user in a relationship may need to determine whether the relationship is worth persisting in. A user would list the positive aspects of the relationship (such as “my significant other buys me flowers regularly”) as well as the negative aspects of the relationship (such as “my significant other forgot my birthday”). The user assigns stones colored and sized proportionally to the severity of each aspect, and places them into the scale. If the stones of a first color are heavier, then the positive aspects outweigh the negative ones, and the relationship may be deemed worthwhile.

Alternatively, the decision-making system may be used to judge situations other than decisions. Any situation having positive and negative aspects may be judged by the system. In particular, the system may be used to teach children about judgement skills, decision making, consequences, and healthy competition, and may aid children in managing expectations and emotions which result from winning or losing. Such a system has benefit in allowing a parent to determine if a child's positive behavior outweighs their negative behavior in regards to a situation or period of time.

A specific application includes a method of tracking of a child's behavior over a chosen period of time and choosing rewards and punishments for associated behaviors. A child may be offered a role in choosing the punishments and behaviors, which in some embodiments may be recorded on papers which are subsequently placed in respective bowls. These punishments and behaviors may be used with the scale in accordance with the weighing of positive and negative behaviors to determine an imbalance. As time progresses, the child may observe which side of the scale is greater, and modify his or her actions to ensure a positive outcome. At the end of the predetermined period, a verdict is determined based upon which bowl outweighs the other, and the appropriate rewards or punishments are enacted. In some situations, the parent may offer a reward when positive choices or behaviors are favored.

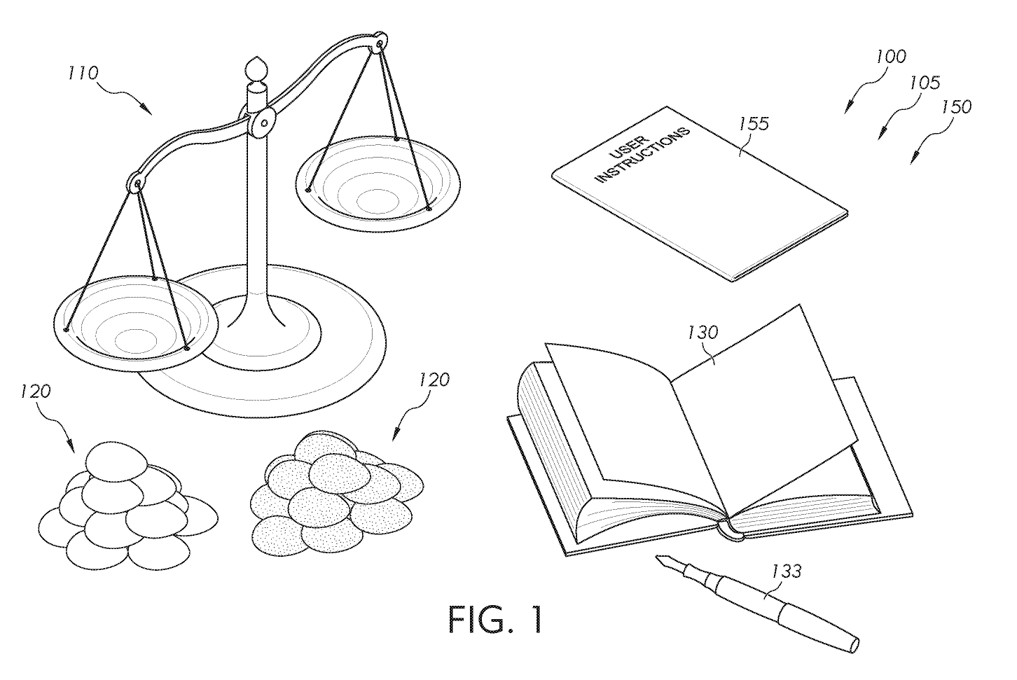

Referring now more specifically to the drawings by numerals of reference, there is shown in FIGS. 1-4, various views of a decision-making system and method 100. FIG. 1 shows a decision-making system and method 100 during an ‘in-use’ condition 150, according to an embodiment of the present disclosure. Here, the decision-making system and method may be beneficial for use by a user 140 to weigh the positive and negative aspects of a decision. As illustrated, the decision-making system and method 100 may include balance scale 110 including stand 111, pivoting balance arm 112 having left member 113, right member 114, and fulcrum 115, at least two receptacles 116 each having basin 117 and rim 118, and at least two receptacle-suspending members 119; plurality of stones 120 comprising weights 121 including selection of stones of a first color 122 and selection of stones of a second color 123; journal 130 including cover 131 and pages 132; and writing utensil 133 configured to record information in journal 130.

Balance scale 110, plurality of stones 120, journal 130, and writing utensil 133 are configured as a kit for making decisions. Journal 130 and writing utensil 133 are used for recording perceived positive and negative attributes of a decision, while plurality of stones 120 comprises a physical placeholder for perceived positive and negative attributes of decision 142. Balance scale 110 helps determine overall positivity or negativity of decision 142 by providing visual representation of decision 142. Balance scale 110 is designed to determine disparity of weight between selection of stones of a first color 122 on one side of balance scale 110 and selection of stones of a second color 123 on the other, providing a material representation of decision-making process 144. Plurality of stones 120 represent varying magnitudes of positivity or negativity. Plurality of stones 120 vary in mass, acting as weights 121.

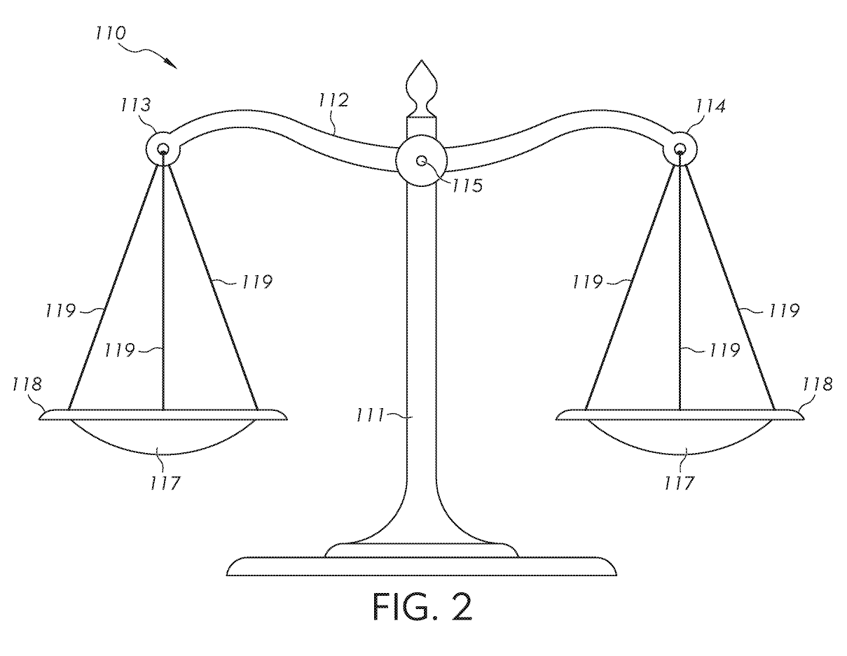

FIG. 2 shows the decision-making system and method 100 of FIG. 1, according to an embodiment of the present disclosure. As above, the decision-making system and method 100 may include balance scale 110, plurality of stones 120, journal 130, and writing utensil 133. Balance scale 110 may include stand 111, pivoting balance arm 112 having left member 113, right member 114, and fulcrum 115, least four receptacles 116 each having basin 117 and rim 118, and at least two receptacle-suspending members 119. Pivoting balance arm 112 of balance scale 110 is oriented horizontally when balanced, and balance scale 110 is oriented vertically, being constructed to support balance scale 110. Pivoting balance arm 112 pivots about fulcrum 115, left member 113 and right member 114 producing equal and opposite moments about fulcrum 115. At least two receptacles 116 are divided equally between left member 113 and right member 114, also producing equal and opposite moments about fulcrum 115, so that balance scale 110 is balanced when empty.

Left member 113 causes a counter-clockwise rotation of pivoting balance arm 112 about fulcrum 115 when the weights are applied, and right member 114 causes a clockwise rotation of pivoting balance arm 112 about fulcrum 115 when the weights are applied. At least two receptacles 116 are designed to contain plurality of stones 120, each having sufficient internal volume for plurality of stones 120. Receptacle-suspending members 119 of balance scale 110 flexibly connect at least two receptacles 116 to pivoting balance arm 112.

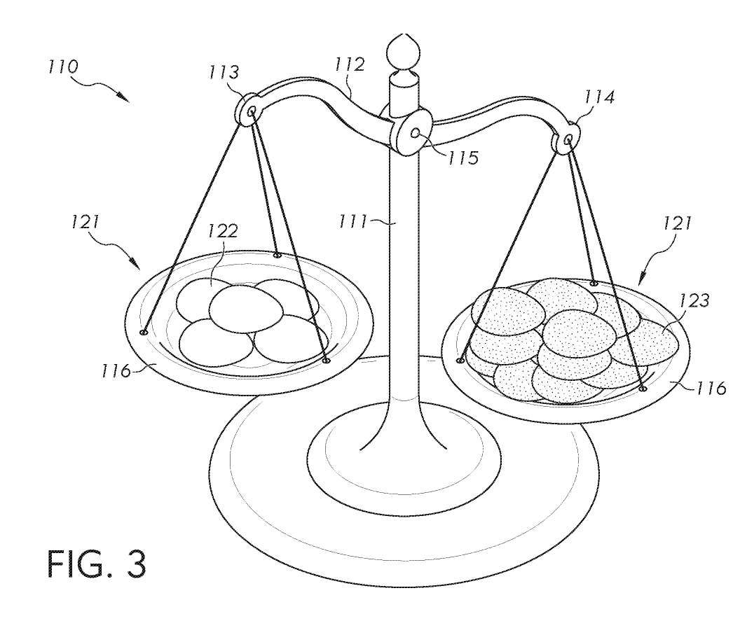

FIG. 3 is a perspective view of the at least two receptacles 116 of FIG. 1, according to an embodiment of the present disclosure. At least two receptacles 116 of balance scale 110 are structured and arranged to receive plurality of stones 120, left member 113 receiving selection of stones of a first color 122 and right member 114 receiving selection of stones of a second color 123. Selection of stones of a first color 122 are weighed against selection of stones of a second color 123. Selection of stones of a first color 122 and selection of stones of a second color 123 thereby cause imbalance between left member 113 and right member 114 when applied in unequal weights. Balance scale 110 visually demonstrates imbalance between weights 121 by rotating either clockwise or counter-clockwise in accordance with weights 121.

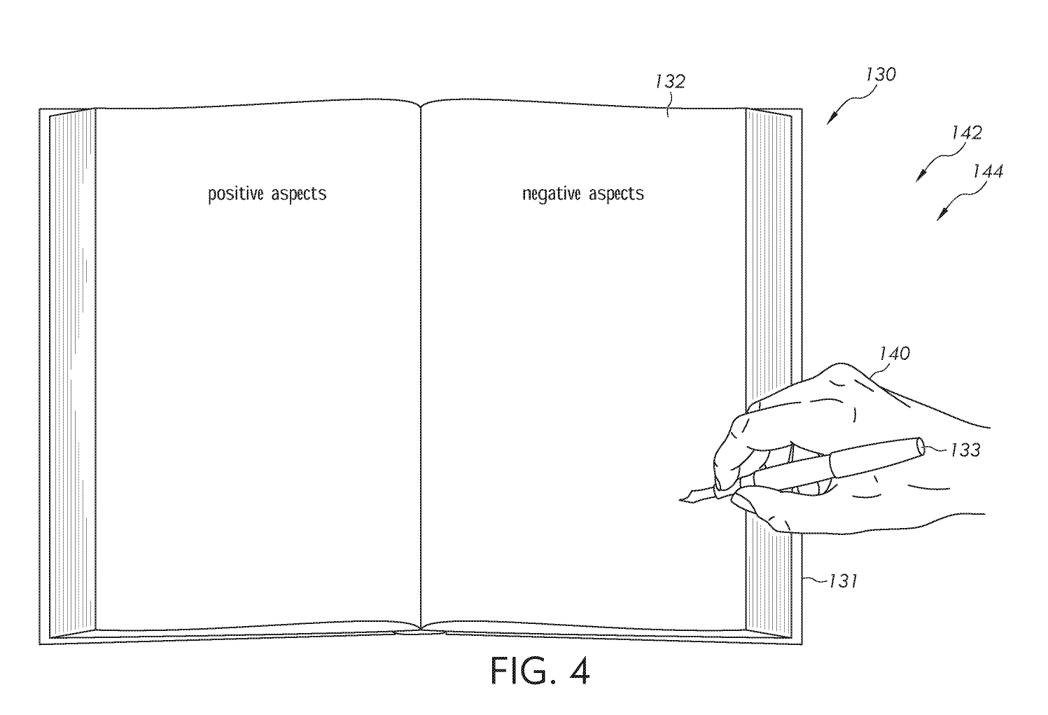

FIG. 4 is a perspective view of journal 130 and writing utensil 133 of FIG. 1, according to an embodiment of the present disclosure. Journal 130 is defined by cover 131 and pages 132. Writing utensil 133 is structured and arranged to write information in journal 130. According to decision-making process 144, writing utensil 133 may be used to record positive and negative aspects of decision 142 in journal 130.

According to one embodiment, the decision-making system and method 100 may be arranged as a kit 105. In particular, the decision-making system and method 100 may further include a set of instructions 155. The instructions 155 may detail functional relationships in relation to the structure of the decision-making system and method 100 (such that the decision-making system and method 100 can be used, maintained, or the like, in a preferred

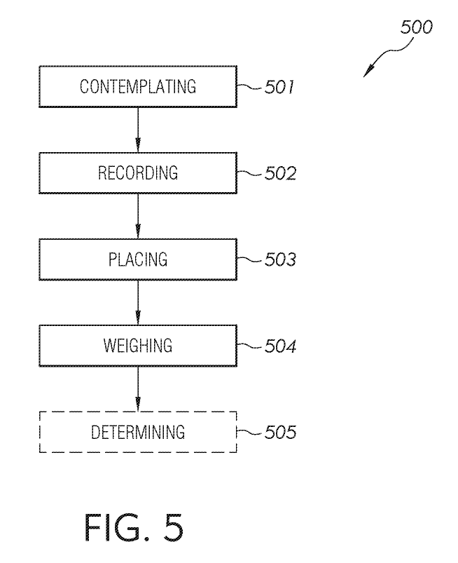

FIG. 5 is a flow diagram illustrating a method for decision-making 500, according to an embodiment of the present disclosure. In particular, the method for decision-making 500 may include one or more components or features of the decision-making system and method 100 as described above. As illustrated, the method for decision-making 500 may include the steps of: step one 501, contemplating positive aspects and negative aspects of decision 142; step two 502, recording positive aspects and negative aspects in journal 130 using writing utensil 133; step three 503, placing plurality of stones 120 in at least one of two receptacles 116 of balance scale 110, selection of stones of a first color 121 of plurality of stones 120 being placed under either left member 113 of pivoting balance 112 arm of balance scale 110 or right member 112 of pivoting balance arm 112 of balance scale 110, and selection of stones of a second color 123 of plurality of stones 120 being placed under an opposite of either left member 113 of pivoting balance arm 112 of balance scale 110 and alternately right member 114 of pivoting balance arm 112 of balance scale 110, selection of stones of a first color 122 of plurality of stones 120 representing positive aspects of decision 142, and selection of stones of a second color 123 of plurality of stones 120 representing negative aspects of decision 142; step four 504, weighing left member 113 of pivoting balance arm 112 of balance scale 110 against right member 114 of pivoting balance arm 112 of balance scale 110; and step five 505, determining a balance and alternately an imbalance of plurality of stones 120, to form a decision based on positive if selection of stones of a first color 122 of plurality of stones 120 outweighs selection of stones of a second color 123 of plurality of stones 120; and decision 142 is negative if selection of stones of a second color 123 of plurality of stones 120 outweighs selection of stones of a first color 122 of plurality of stones 120, decision 142 is neutral if selection of stones of a first color 122 of plurality of stones 120 is balanced with selection of stones of a second color 123 of plurality of stones 120; wherein user 140 is able to enact decision 142 made by decision-making process 144.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for decision-making (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A decision-making system, the decision-making system comprising:
a balance scale including,
a stand,
a pivoting balance arm having a left member, a right member, and a fulcrum,
at least two receptacles each having a basin and a rim, and
and at least two receptacle-suspending members;
a plurality of stones comprising weights including,
a selection of stones of a first color, and
a selection of stones of a second color;
a journal including a cover and pages; and
a writing utensil configured to record information in said journal;
wherein said balance scale, said plurality of stones, said journal, and said writing utensil are configured to organize a kit for making decisions;
wherein said journal and said writing utensil in combination comprise a means for recording perceived positive and negative attributes of a decision;
wherein said plurality of stones comprises a physical placeholder for said perceived positive and negative attributes of a decision;
wherein said balance scale comprises a means for determining an overall positivity or negativity of a decision;
wherein said balance scale in functional combination comprise said stand, said pivoting balance arm having said left member, said right member, and said fulcrum, said least four receptacles each having said basin and said rim, and said at least two receptacle-suspending members, said balance scale being structured and arranged to determine an imbalance of weight between two opposed selections of said plurality of stones; and
wherein said decision-making system provides material representation of a decision-making process.

2. The decision-making system of claim 1, wherein said plurality of stones vary in individual shape and volume, each of said plurality of stones being of said selection of stones of a first color, or of said selection of stones of a second color;

3. The decision-making system of claim 1, wherein said plurality of stones comprise weights of varying mass for applying forces to said balance scale.

4. The decision-making system of claim 1, wherein said pivoting balance arm of said balance scale is oriented horizontally when balanced.

5. The decision-making system of claim 1, wherein said stand of said balance scale is oriented vertically, said stand of said balance scale being structured and arranged to support said balance scale on a surface.

6. The decision-making system of claim 1, wherein said pivoting balance arm of said balance scale pivots about said fulcrum of said pivoting balance arm of said balance scale, said left member of said pivoting balance arm of said balance scale and said right member of said pivoting balance arm of said balance scale producing equal and opposite moments about said fulcrum of said pivoting balance arm of said balance scale.

7. The decision-making system of claim 1, wherein said left member of said pivoting balance arm of said balance scale and said right member of said pivoting balance arm of said balance scale each support half of said at least two receptacles of said balance scale by means of at least two said receptacle-suspending members of said balance scale, each half of said at least two receptacles of said balance scale and said at least two receptacle-suspending members of said balance scale producing equal and opposite moments about said fulcrum of said pivoting balance arm of said balance scale.

8. The decision-making system of claim 7, wherein said left member of said pivoting balance arm of said balance scale causes a counter-clockwise rotation of said pivoting balance arm of said balance scale about said fulcrum of said pivoting balance arm of said balance scale when said weights are applied, and said right member of said pivoting balance arm of said balance scale causes a clockwise rotation of said pivoting balance arm of said balance scale about said fulcrum of said pivoting balance arm of said balance scale when said weights are applied.

9. The decision-making system of claim 8, wherein said at least two receptacles of said balance scale comprise receivers for retaining and supporting said plurality of stones.

10. The decision-making system of claim 9, wherein said basins of said at least two receptacles of said balance scale are of sufficient internal volume to contain said plurality of stones in varying quantities.

11. The decision-making system of claim 1, wherein said at least two receptacle-suspending members of said balance scale comprise flexible connection means each applying a moment to said pivoting balance arm of said balance scale.

12. The decision-making system of claim 10, wherein said at least two receptacles of said balance scale are structured and arranged for receiving said plurality of stones, said left member of said pivoting balance arm of said balance scale being arranged to support either said selection of stones of a first color of said plurality of stones or said selection of stones of a second color of said plurality of stones, and said right member of said pivoting balance arm of said balance scale being arranged to support either said selection of stones of a first color of said plurality of stones or said selection of stones of a second color of said plurality of stones, said left member of said pivoting balance arm of said balance scale and said right member of said pivoting balance arm of said balance scale each receiving an opposite color of said plurality of stones.

13. The decision-making system of claim 12, wherein said plurality of stones are configured to cause an imbalance between said left member of said pivoting balance arm of said balance scale and said right member of said pivoting balance arm of said balance scale when said selection of stones of a first color of said plurality of stones and said selection of stones of a second color of said plurality of stones are applied in a disparity of weight.

14. The decision-making system of claim 13, wherein said balance scale is structured and arranged to visually demonstrate an imbalance between said weights by rotating said pivoting balance arm of said balance scale either clockwise and alternately counter-clockwise about said fulcrum of said pivoting balance arm of said balance scale.

15. A kit for a decision-making system comprising:
a balance scale including,
a stand,
a pivoting balance arm having a left member, a right member, and a fulcrum,
at least two receptacles each having a basin and a rim, and
and at least two receptacle-suspending members;
a plurality of stones configured to be placed and weighed in said receptacles of said balance scale including,
a selection of stones of a first color, and
a selection of stones of a second color;
a journal including a cover and pages;
a writing utensil configured to record information in said journal; and
a set of user instructions; and
wherein said decision-making system provides material representation of a decision-making process.

16. A method of decision-making, the method comprising the steps of:
contemplating positive aspects and negative aspects of a decision;
recording said positive aspects and said negative aspects in a journal using a writing utensil;
placing a plurality of stones in at least one of two receptacles of a balance scale, selection of stones of a first color of a plurality of stones being placed under either a left member of a pivoting balance arm of a balance scale or a right member of said pivoting balance arm of said balance scale, and said selection of stones of a second color of said plurality of stones being placed under an opposite of either said left member of said pivoting balance arm of said balance scale and alternately said right member of said pivoting balance arm of said balance scale, said selection of stones of a first color of said plurality of stones representing said positive aspects of said decision, and said selection of stones of a second color of said plurality of stones representing said negative aspects of said decision;
weighing said left member of said pivoting balance arm of said balance scale against said right member of said pivoting balance arm of said balance scale;
determining a balance and alternately an imbalance of said plurality of stones, to form a decision based on positive if said selection of stones of a first color of said plurality of stones outweighs said selection of stones of a second color of said plurality of stones; and said decision is negative if said selection of stones of a second color of said plurality of stones outweighs said selection of stones of a first color of said plurality of stones, said decision is neutral if said selection of stones of a first color of said plurality
of stones is balanced with said selection of stones of a second color of said plurality of stones; and
wherein a user is able to enact said decision made by said method of decision-making.

17. The method of decision-making of claim 16, wherein a quantity of said selection of stones of a first color of said plurality of stones is proportional to the quantity of said positive aspects of said decision, and the quantity of said selection of stones of a second color of said plurality of stones is proportional to the quantity of said negative aspects of said decision.

18. The method of decision-making of claim 17, wherein magnitudes of said positive or negative aspects of said decision are represented by said plurality of stone's individual weights.
